(19) United States
(12) Patent Application Publication
(10) Pub. No.: US 2010/0065796 A1
(43) Pub. Date: Mar. 18, 2010

(54) BUILDING AID

(76) Inventor: Michael Crowe, Swan Hill (AU)

Correspondence Address: EDWIN D. SCHINDLER, FIVE HIRSCH AVENUE, P.O. BOX 966, CORAM, NY, 11727-0966, US

(21) Appl. No.: 12/559,920

(22) Filed: Sep. 15, 2009

(30) Foreign Application Priority Data
Sep. 15, 2008 (AU) 2008904818

(51) Int. Cl. B66F 11/00; B66F 15/00

(52) U.S. Cl. 254/131; 254/120

(57) ABSTRACT

A tool for temporarily lifting and supporting reinforcing mesh above an underlying surface includes an elongate rod that can be held at a first end and which has a portion at a second end opposing the first end. The elongate rod, which can engage under an element of mesh, is mounted on a base member for turning on the underlying surface with a rotary movement of the elongate rod, so that movement of the elongate rod acts to lift the element of mesh.

### AREA OF THE INVENTION

This invention relates to the area of building construction and in particular to a device which assists in the area of occupational health and safety by providing a means of manipulating reinforcing mesh onto support means as is required during the process of pouring concrete slabs and the like.

### BACKGROUND TO THE INVENTION

Concrete is used as a base for buildings of all types. Such concrete however becomes cracked due to many factors from the curing process itself to thermal expansion and contraction and load induced stresses. In order to combat the deterioration it is customary for concrete slabs to be reinforced with metal rods or meshes or the like.

In order to optimise the strength of the concrete there is a preferred height at which such reinforcing mesh should be positioned within it and it is further desirable that the height of the mesh be constant throughout any given concrete slab.

In order to achieve this optimal height for the mesh, such that it remains at its designed height both before during and after the concrete pour, a system of supports are used to elevate the mesh above the base surface. Such supports will be referred to herein as bar chairs.

Commonly used bar chairs are not required to perform any structural function other than to act as spacers and as such are customarily of a light weight plastic construction. These are inserted at appropriate locations under the mesh once it has been laid over the base where the concrete is to be poured (over large areas) and are continuously placed in position while the concrete is being poured.

In order to position the bar chairs it is necessary for a person to lift the metal mesh while the bar chair is inserted under the part of the mesh to be supported. This process often requires one person to lift the mesh, either by hand or using a hook device or the like, while another inserts the bar chair.

This process is both labour intensive, time consuming and a potential cause of back injury to the person lifting particularly as other people standing on the mesh exacerbate the difficulty of the task.

Where concrete is to be poured into a trench a person has to lie on the edge of the trench and reach down to lift the mesh to insert the bar chairs which is a physically demanding exercise.

### OUTLINE OF THE INVENTION

It is an object of this invention to ameliorate the above problems by providing a means for lifting reinforcing mesh which is laid out on a surface to be covered with concrete in a manner which permits ready positioning of a bar chair support where required. It is a further object of the invention to provide such a means which can permit a single person to both lift the mesh and insert the bar chair.

The invention is a tool for temporarily lifting and supporting reinforcing mesh above an underlying surface, said tool including an elongate rod adapted to be held at a first end thereof and having a portion at an opposing end thereof adapted to engage under an element of the mesh, said rod being mounted on a base member adapted to turn on the surface with rotary movement of the rod such that said movement acts to lift the mesh element.

It is preferred the portion of the rod used to engage with the reinforcing mesh be some upwardly directed hook device.

It is further preferred that the rod have a handle means at an opposing end to facilitate movement of the rod.

It is preferred that the member on which the rod is mounted is a device having a curved surface such that the rod is mounted tangentially to the curved surface. While the invention is not restricted as to the form of this member it provides a simple surface for that part of the tool which can readily rotate on the surface underlying the reinforcing mesh.

It is further preferred that the lateral dimension of the cylindrical member be such as to readily locate within the mesh spacing.

In order that the invention may be more readily understood we will describe by way of non limiting example a specific embodiment of the invention with reference to the accompanying drawings.

### BRIEF DESCRIPTION OF THE DRAWING FIGURES

FIG. 1 Shows a perspective view of the tool of the invention;

FIG. 2a Shows the toll inserted under reinforcing mesh;

FIG. 2b Shows the tool lifting the mesh for insertion of a bar stool;

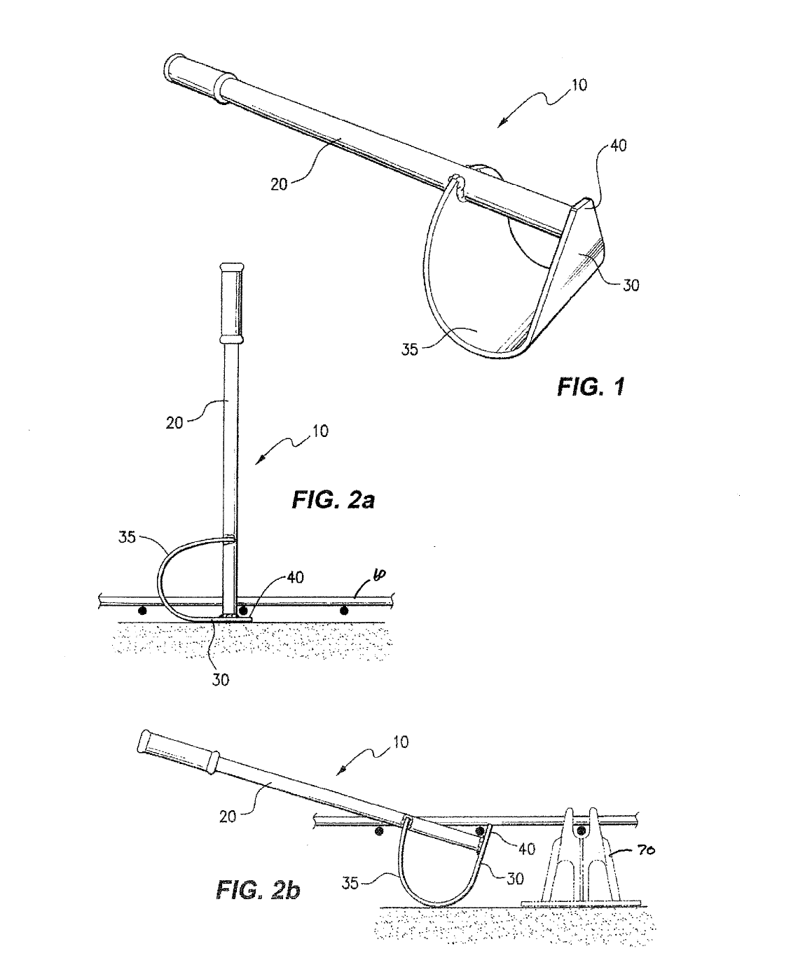

### DESCRIPTION OF AN EMBODIMENT OF THE INVENTION

In a preferred embodiment of the invention a tool 10 for lifting reinforcing mesh above an underlying surface is provided which permits a portion of the mesh 60 to be readily lifted with one hand while the other can be used to insert a bar chair 70 below the mesh portion to be supported.

The tool consists of a rod 20 mounted tangentially to a base member 30 having a curved shape 35 adapted to rotate on the surface underlying the mesh when the rod is levered up or down.

The rod 20 has a handle 25 at one end and a hook type device 40 angled upwards at an opposing end of the rod which device in this embodiment of the invention is provided by an upwards extension of the far end of the base member 30.

While this embodiment is preferred the hook type device could be located at the end of the rod independently of the base member if the base member were to be located further back along the rod.

For example in another embodiment of the invention the rod is connected to a base member which is a cylindrical element adjacent the hook device.

In either embodiment the arrangement is such that the end of the tool 10 having the base member 30 is inserted between adjacent mesh rods with the base member positioned on the surface underlying the mesh.

It is then a simple matter to locate the hook type device 40 under a mesh element to be lifted which process is effected by pushing down on the handle causing the base member to rotate. Simply holding the handle down holds the mesh element up while the bar chair is inserted below it.

The use of this tool also makes the laying of reinforcing mesh in trenches a relatively simple matter as a person leaning into the trench does not have to exert much force on the tool to lift any mesh element while the bar chair is inserted below it.

As previously stated the invention is not restricted to any particular shape or design of the tool other than that it is a mechanical device which can lever up reinforcing mesh while bar chair supports for the mesh are positioned.

Thus, while we have described herein one particular embodiment of the invention it is to be understood therefore that variations in and modifications in the features described may be made without departing from the scope of the invention.

What is claimed is:

1. A tool for temporarily lifting and supporting reinforcing mesh above an underlying surface, comprising:
an elongate rod for being held at a first end and having a portion at a second end opposing said first end thereof for engaging under an element of mesh; and,
a base member upon which said elongate rod is mounted for turning on the underlying surface with a rotary movement of said elongate rod, so that the rotary movement lifts the element of mesh.

2. The tool for temporarily lifting and supporting reinforcing mesh above an underlying surface according to claim 1, wherein said portion of said elongate rod used for engaging with the element of mesh includes an upwardly directed hooking device.

3. The tool for temporarily lifting and supporting reinforcing mesh above an underlying surface according to claim 2, wherein said upwardly directed hooking device is an extension of an outer extremity of said base member.

4. The tool for temporarily lifting and supporting reinforcing mesh above an underlying surface according to claim 3, wherein said base member is arcuate in longitudinal cross-section.

5. The tool for temporarily lifting and supporting reinforcing mesh above an underlying surface according to claim 1, wherein said base member is arcuate in longitudinal cross-section.

6. The tool for temporarily lifting and supporting reinforcing mesh above an underlying surface according to claim 5, wherein said base member has a curved surface with said elongate rod mounted tangentially to said curved surface.

7. The tool for temporarily lifting and supporting reinforcing mesh above an underlying surface according to claim 1, wherein the first end of said elongate rod includes a hand grip.
